(19) United States
(12) Patent Application Publication
(10) Pub. No.: US 2025/0205753 A1
(43) Pub. Date: Jun. 26, 2025

(54) Air Blower

(71) Applicant: Vornado Air, LLC, Andover, KS (US)

(72) Inventors: Joshua Weed, Wichita, KS (US); Shawn Berkley, Wichita, KS (US); Gregory Pease, Andover, KS (US)

(21) Appl. No.: 18/991,153

(22) Filed: Dec. 20, 2024

Related U.S. Application Data
(63) Continuation of application No. 29/935,571, filed on Apr. 2, 2024.
(60) Provisional application No. 63/613,682, filed on Dec. 21, 2023.

(51) Int. Cl. B08B 5/02

(52) U.S. Cl. CPC B08B 5/02

(57) ABSTRACT

A portable, free-standing air blower is provided. The air blower comprises a main housing with a rotation housing and an extendable arm featuring an air outlet and brush tip. A fan and motor assembly within the main housing generates airflow, enhanced by a vortex lid for improved efficiency. The handle includes a rechargeable battery, visual indicator, and controller for operational adjustments. The arm is rotatably adjustable between at least 0 to 180 degrees relative to the main housing. The air blower combines portability, robust airflow mechanisms, and user-friendly features to provide a multi-functional air blower suitable for diverse environments.

### RELATED APPLICATIONS

This application is a continuation of U.S. Design patent application Ser. No. 29/935,571, filed on Apr. 2, 2024, titled “AIR BLOWER,” and claims the benefit under 35 U.S.C. § 119(e) of U.S. Provisional Patent Application Ser. No. 63/613,682, filed on Dec. 21, 2023, titled “AIR BLOWER,” the entire contents of which are incorporated by reference herein.

### FIELD OF INVENTION

The present invention relates to an air blower, specifically to a high-velocity compact air blower designed for versatile applications including but not limited to cleaning and dusting.

### BACKGROUND

Cleaning sensitive surfaces like electronics, furniture, and mechanical parts often require multiple tools, like air blowers and brushes, to remove dust, debris, and other particles effectively without using water or other liquids. However, using multiple tools can be cumbersome and time-consuming. Therefore, there is a need for a multi-functional cleaning appliance that can perform both blowing and brushing tasks efficiently.

Further, commercially available electronic air blowers generally include, for example, an electric motor that drives a fan blade, which then blows air out from an arm nozzle. Existing designs, however, have a fixed or limited angle between the main housing of the air blower and arm nozzle, making it difficult for users to comfortably reach different parts of equipment and other sensitive devices. Therefore, there is a need for a more flexible and intuitive design that allows for an adjustable angle between the main housing and arm nozzle.

### SUMMARY OF THE INVENTION

The present invention provides a air blower designed for portability, versatility, and efficiency. The air blower features a main housing including a handle having a longitudinal axis and a rotation housing and a rotation housing rotatably attached to the main housing. The air blower further includes an arm having a longitudinal axis extending from the rotation housing and having an air outlet at its distal end. A fan is positioned within the main housing a motor for driving the fan is also positioned within the main housing. The arm can be configured to rotate about a rotation axis relative to the main housing. The rotation housing is further frictionally rotatable relative to the main housing.

In another example, the air blower of the present invention includes a main housing having a head portion and a handle having a longitudinal axis. The arm has a distal end and a proximal end. The proximal end of the arm is rotatably attached to the head portion. A fan and motor is positioned within the head portion. The arm is rotatable between at least 0 and 180 degrees relative to the longitudinal axis of the handle.

In yet another example, the air blower of the present invention includes a main housing including a handle having a longitudinal axis and an arm having a distal end and proximal end. The proximal end of the arm is rotatably attached to the main housing and the distal end of the arm includes an air outlet. A brush tip having brush bristles is further provided on the distal end of the arm. The brush tip can be moved along a longitudinal axis of the arm between a first extended position and a second retracted position. The brush bristles may further be circumferentially arranged as to create a central opening for air to pass through from the air outlet.

Other devices, apparatus, systems, methods, features and advantages of the invention are or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF FIGURES

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a rear perspective view of the right side of one example of an air blower of the present invention.

FIG. 2 is a rear perspective view of the left side of the air blower of FIG. 1.

FIG. 3 is a front perspective view of the right side of the air blower of FIG. 1, where the arm is angled parallel relative to the handle.

FIG. 4 is a rear perspective view of the left side of the air blower of FIG. 3.

FIG. 5 is a perspective view of the brush tip in a first position extended on the arm of the air blower of FIG. 1.

FIG. 6 is a perspective view of the brush tip in a second position retracted on the arm of the air blower of FIG. 1.

FIG. 7 is an exploded view of the air blower of FIG. 1.

### DETAILED DESCRIPTION OF THE INVENTION

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

In this application, the term “substantially,” “approximately,” or “about,” when modifying a specified numerical value, may be taken to encompass a range of values that include +/−10% of such numerical value. Further, such as “communicate,” and “in . . . communication with,” or “interfaces” or “interfaces with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate or interface with a second component is not intended to exclude the possibility that additional components may be present between, and/or operatively associated or engaged with, the first and second components.

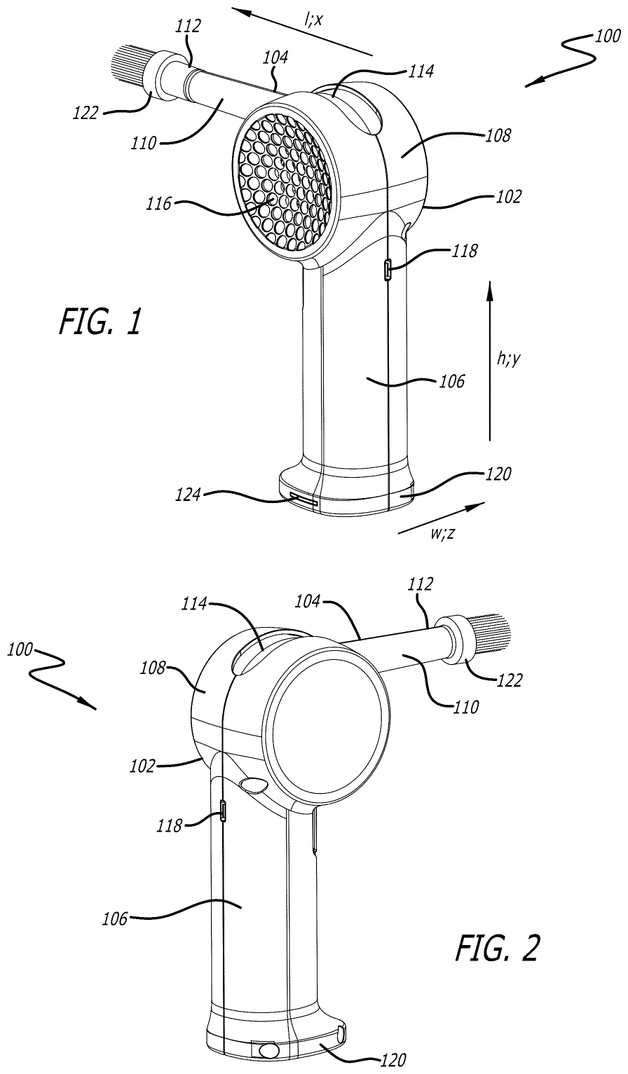

For purposes of reference and description, the air blower 100 of the present invention is considered to have a horizontal axis (x-axis), vertical axis (y-axis) and a z-axis, as shown in FIG. 1 along which the components of the air blower 100 are positioned relative to each other. Terms such as “axial” and “axially” are assumed to refer to the respective axis or any direction or axis parallel to the device axis, unless indicated otherwise or the context dictates otherwise. For convenience, movement relative to a device axis may alternatively encompass movement relative to an axis that is parallel to the device axis that is specifically illustrated in FIG. 1, unless the context dictates otherwise. Thus, linear translation “along the device axis z” is not limited to translation directly on (coincident with) the device axis, but also encompasses translation parallel to the device axis z, depending on the context. Similarly, rotation “about the device axis y” also encompasses rotation about an axis that is parallel to the device axis y, depending on the context.

Further, the air blower 100 of the present invention is considered to have a height (H), length (L) and width (W), as also shown in FIG. 1.

As illustrated and discussed in the following, examples of an air blower are provided. The air blower 100 of the present invention is a portable, free-standing air blower. “Portable” being defined as having the ability to be carried or moved with ease. “Free standing” being defined as having the ability to remain stable and upright without external restraints. It should further be understood that the term “air blower” may interchangeably be used with the terms “fan, “air circulator” or any other term that refers to an apparatus that creates a current of air for cooling and/or heating.

FIGS. 1 and 2 are rear perspective views of the right and left side of one example of the air blower 100 of the present invention. As shown in FIG. 1, air blower 100 comprises a main housing 102 and rotation housing 104 rotatably attached to the main housing 102 such that rotation housing 104 rotates relative to main housing 102. Main housing 102 comprises a head portion 108 and a handle 106 extending from head portion 108 along the height of air blower 100. Rotation housing 104 comprises an arm 110 or arm nozzle having a hollow interior channel for air passage.

Arm 110 comprises a distal end 112 and proximal end 114. Distal end 112 of arm includes an air outlet 602 and a brush tip 122. Proximal end 114 of arm 110 is rotatably attached to head portion 108 of main housing 102. Head portion 108 includes an air intake 116 proximate the fan 718 comprising of a plurality of apertures. In operation, air is drawn through the plurality of apertures of air intake 116 into an interior space of head portion 108 and rotation housing 104, where an air stream is created by fan 718 and directed through the interior of arm 110 and discharged through air outlet 602.

Handle 106 has a longitudinal axis that runs along or parallel to the y-axis or height of air blower 100. Handle 106 serves as the primary holding point for the user. Handle 106 may be designed with an ergonomic grip to increase comfort during use, potentially featuring textured or rubberized materials. Handle may further include a base 120 having a flat bottom for allowing air blower 100 to be free-standing such that it can remain stable and upright without external restraints. Handle 106 may further include a visual indicator 124 positioned on the base 120 near the bottom of air blower 100. Visual indicator 124 includes a transparent or translucent lens and at least one light source (e.g., light emitting diode (LED)) that is configured to illuminate light. Visual indicator 124 is configured to indicate a state of operation of air blower 100. For example, visual indicator 124 may be configured to illuminate light to indicate a charging state of air blower 100 and/or configured to illuminate light to indicate the speed of the motor 704 and fan 718. Handle may further include a plug receptacle 118 for charging or recharging a power source 724 housed within handle 106 of main housing 102. In the present case, power source 724 comprises a rechargeable battery.

As shown in FIG. 2, handle 106 further comprises controller 202 in the form of a push button that operates as an on/off button and can also operate to control the speed of motor 704. The power source 724, visual indicator 124, plug receptacle 118, motor 704, and controller 202 are all in electrical communication with one another. In one example, controller 202 includes a circuit board that electrically communicates with a circuit board of motor 704 for controlling the operation and/or speed of motor 704. The circuit board of controller 202 is in further communication with, or electrically connected to, power source 724. Power source 724 provides power to the circuit board of controller 202, and may provide power directly to the motor 704, or indirectly to the motor through the motor's circuit board, either of which provides the necessary power to motor 704. Optionally, power source 724 may be one or more batteries, one or more rechargeable batteries, and/or the air blower 100 may draw power through an external power source by, for example, plugging into a power outlet, to operate the air blower 100, to recharge the batteries, or both.

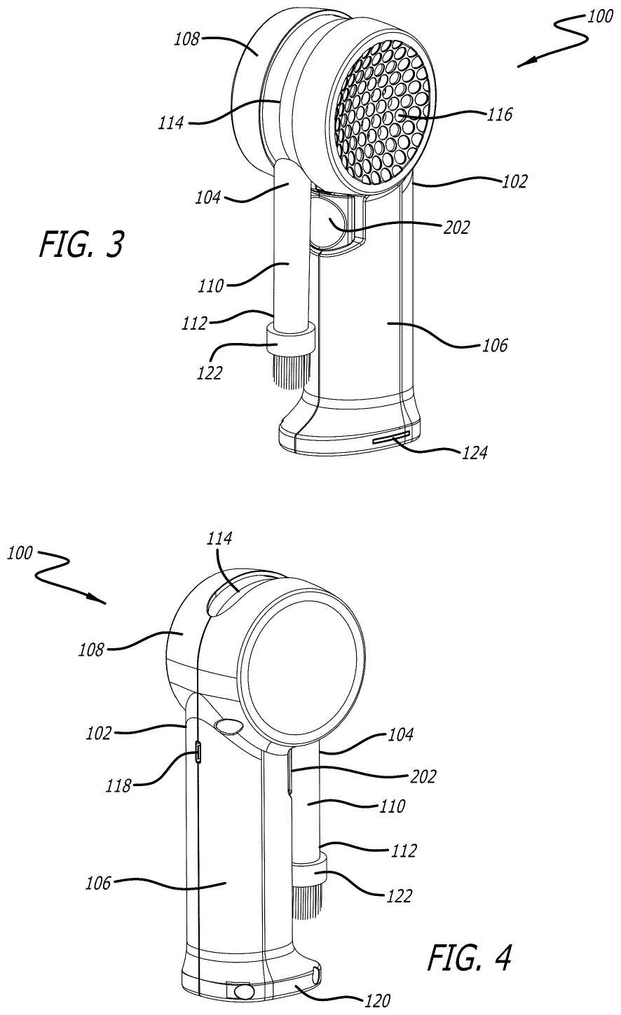

FIG. 3 is a front perspective view of the right side of the air blower 100 and FIG. 4 is a rear perspective view of the left side of the air blower 100. Both FIGS. 3 and 4 illustrate arm 110 in a different position relative to the main housing 102 compared to FIGS. 1 and 2. As stated previously, arm 110 is rotatably attached to main housing 102. The rotatable attachment allows a user to manually rotate arm 110 relative to main housing 102. Arm 110 is rotated about a rotation axis that runs parallel to the z-axis of air blower 100 or runs perpendicular to the x or y-axis of air blower 100. In some examples, the rotation axis of arm 110 is the same as the rotation axis of motor 704 and/or fan 718.

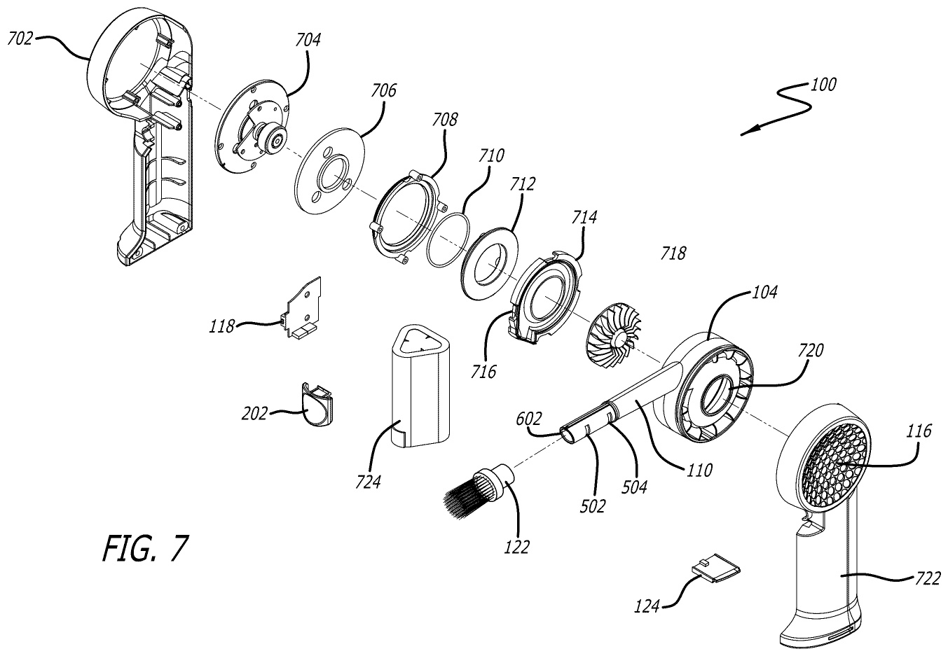

The proximal end 114 of arm 110 is rotatably attached to head 108 of main housing 102. In one example, arm 110 is frictionally rotatable relative to main housing 102. In other words, at least some friction may be provided between arm 110 and main housing 102 to allow arm 110 to be frictionally secured at a desired angle relative to main housing 102. In operation, the user may manually rotate arm 110 to a desired position relative to main housing 102 and such desired position will be frictionally secured. It should be understood that a user may operate air blower 100 regardless of the position of arm 110 relative to main housing 102. In other examples, arm 110 may be selectively locked and unlocked at various angles relative to main housing 102 by a locking mechanism. Additional details regarding the frictional rotation of arm 110 will be discussed in connection with FIG. 7.

It should also be understood from the figures that arm 110 can be rotated to any angle degree between 0-180 relative to the longitudinal axis of handle 106 of main housing 102. For example, FIGS. 1 and 2 illustrate the longitudinal axis of arm 110 positioned at a 90-degree angle relative to the longitudinal axis of handle 106, while FIGS. 3 and 4 illustrate the longitudinal axis of arm 110 positioned at a 0-degree angle relative to the longitudinal axis of handle 106. While FIGS. 3 and 4 illustrate the longitudinal axis of arm at a 0 degree angle relative to the longitudinal axis of handle 106 such that the distal end 112 of arm 110 is positioned proximate to handle 106 (for storage or portability purposes), it should also be understood that longitudinal axis of arm can be rotated to a 180 degree angle relative to the longitudinal axis of handle 106 such that the distal end 112 of arm 110 is positioned distant to handle 106.

Not only does positioning the longitudinal axis of arm 110 at a 0-degree angle relative to the longitudinal axis of handle 106 allow for easier storage and portability of air blower 100, but such positioning also further protects controller 202 from accidentally being pressed or activated when air blower 100 is being carried or stored. In other words, when arm 110 is positioned as shown in FIGS. 3 and 4, at least a portion of arm covers controller 202, thereby reducing the risk that controller will accidentally get activated when air blower 100 is being carried or stored.

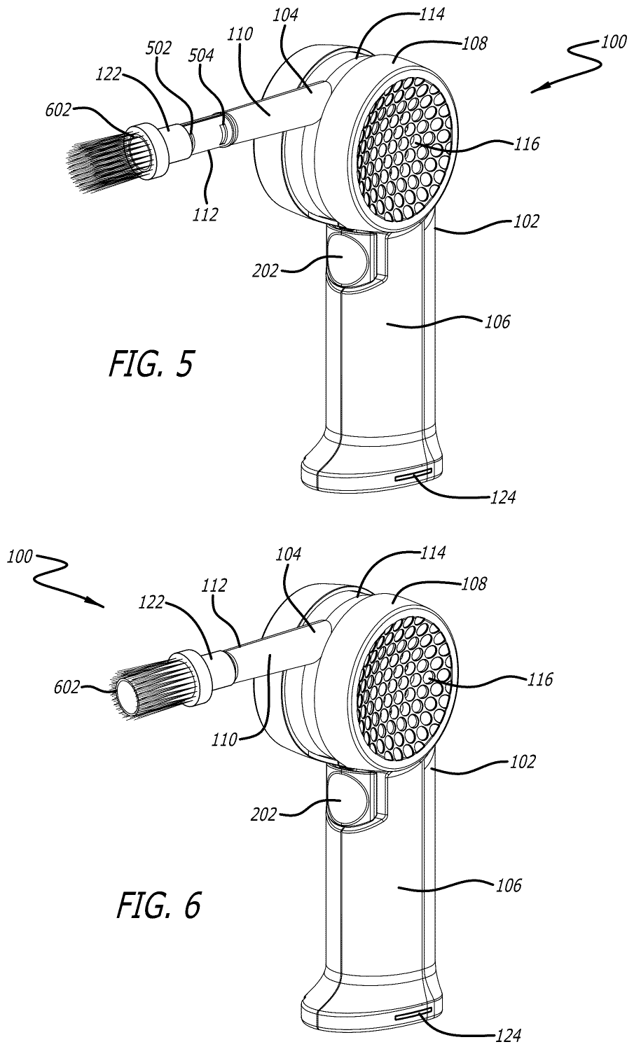

FIGS. 5 and 6 illustrate the brush tip 122 of the present invention. In particular, FIG. 5 is a perspective view of brush tip 122 in a first position extended on the arm 110 of air blower 100, while FIG. 6 is a perspective view of the brush tip 122 in a second position retracted on the arm 110 of air blower 100. As shown in FIG. 5, brush tip 122 may be extended on the arm 110 to allow a user to utilize the air blower 100 as a brushing tool alone or allows a user to utilize the air blower 100 as a brushing and blower tool simultaneously. As shown in the figures, brush bristles of brush tip 122 are positioned circumferentially on brush tip 122, thereby creating a center opening for allowing air discharged from air outlet 602 to pass through. Such design allows air blower 100 to be utilized as both a brushing and blower tool separately or simultaneously.

FIG. 6 shows brush tip 122 in a retracted second position on arm 110. Having the brush tip 122 in this retracted position on arm 110 allows a user to utilize the blower 100 as a blower tool without having to remove, and potentially misplace, brush tip 122. In other words, the retractable position shown on FIG. 6 of brush tip 122 on arm 110 of air blower 100 acts as a convenient storage for brush tip 122 when not in use. Further, when brush tip 122 is in its retracted position, air outlet 602 extends through the brush bristles of brush tip 122, thereby maximizing the air target efficiency of air discharged from air outlet 602 by minimizing air impedance from the brush bristles of brush tip 122.

Brush tip 122 may attach to arm 110 via an attachment mechanism that allows brush tip to extend and retract on arm 110. Such mechanism may include but is not limited to friction fit, clips, magnets, screws, or biasing mechanisms. For example, distal end 112 of arm 110 may include at least a first and second detent or groove 502, 504 that correspond with first and second projections that protrude from the interior of brush tip 122 that fits into grooves 502, 504, creating a positive locking point, effectively holding brush tip 122 and distal end 112 of arm 110 together in a specific position until deliberate force is applied to disengage them; essentially acting as a positive stop or “click” mechanism to prevent accidental detachment. FIG. 5 shows at least one interior projection of brush tip 122 disengaged with at least one groove 504 of arm 110, while FIG. 6 shows at least one interior projection of brush tip 122 engaged with at least one groove 504 of arm 110. In another example, at least one interior projection of brush tip 122 may engage with first groove 502 and not second groove 504 when brush tip is in its extended position, while the at least one interior projection of brush tip 122 may engage with second groove 504 when brush tip is in its retracted position.

It should also be understood that in other examples, the present invention may also allow for multiple brush tips or nozzle tips (each having varying shapes or textures) to interchangeably removably attach to arm 110. Such attachment mechanism may include but is not limited to friction fit, clips, magnets, screws, or biasing mechanisms.

FIG. 7 is an exploded view of air blower 100. In particular, air blower comprises a main housing 102 having right and left housing sides 702, 722 that together houses a majority of the components of air blower 100. In particular, air blower 100 comprises a blower assembly that comprises a fan 718, a motor 704 having a motor output shaft and a motor mount 706 that motor 704 is mounted to. As shown in FIG. 7, fan 718 is constructed as a single unit and is an impeller fan having a plurality of blades. Fan 718 is coupled to motor output shaft of motor 704. Motor mount 706 is used to mount motor 704 to the main housing 102, namely the left housing side 702.

Air blower 100 further comprises a rotation mount. Rotation mount may comprise of an outer rotation mount 708 and/or an inner rotation mount 712. The rotation housing 104 and/or proximal end 114 of arm 110 is mounted to rotation mount. When mounted to rotation mount, both rotation housing 104 and rotation mount rotate relative to main housing 102 and motor mount 706. In particular, an o-ring 710 is positioned between motor mount 707 and rotation mount, namely inner rotation mount 712. O-ring 710 may be made of any frictional material, including but not limited to a rubberized material. In one example, o-ring 710 is fixed to inner rotation mount 712 and rubs against a surface of motor mount 706 when rotation housing 104 is rotated, thereby creating rotational friction force. In another example, o-ring 710 is fixed to motor mount 706 and rubs against a surface of inner rotation mount 712 when rotation housing 104 is rotated, thereby creating rotational friction force. In either example, rotational friction force is created due to the contact between a rubberized material and the surface it is sliding against. Such frictional engagement mechanism allows arm 110 to be frictionally secured at any desired angle relative to main housing 102.

Air blower 100 also comprises a vortex lid 714 which covers fan 718. The vortex design of vortex lid 714 creates a more efficient and powerful airflow by swirling the air as it is created by fan 718, resulting in increased air circulation. Vortex lid 714 further includes a channel 716 for allowing air created by fan 718 to enter into arm 100 and ultimately discharged from air outlet 602.

In operation, motor 704 rotates blower fan 718. The rotation of the fan 718 and about the axis of rotation of motor output shaft of motor 704 creates an air flow that swirls within the vortex lid 714 and through channel 716 into arm 110 and discharged from outlet 602. Motor 704 may be an electric motor using AC current or DC current.

As further shown in FIG. 7, at least one battery 724 is positioned within the handle 106. A stated above battery 724 may provide power directly to the motor 704, or indirectly to the motor 704 through a circuit board, either of which provides the necessary power to the motor 704. Battery 724 may be comprised of lithium-ion battery cells connected in series to produce the voltage necessary to power the air blower 100, Such battery cells are commercially available from many different suppliers.

It will be understood, and appreciated by persons skilled in the art, that one or more processes, sub-processes, or process steps described above may be performed by hardware and/or software. If the process is performed by software, the software may reside in software memory (not shown) in a suitable electronic processing component or system. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It will be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. An air blower comprising:
a main housing including a handle having a longitudinal axis;
a rotation housing rotatably attached to the main housing;
an arm having a longitudinal axis extending from the rotation housing and having an air outlet at its distal end;
a fan positioned within the main housing; and
a motor driving the fan, wherein the arm is configured to rotate about a rotation axis relative to the main housing.

2. The air blower of claim 1, where the arm is rotatable between at least 0 and 180 degrees relative to the longitudinal axis of the handle.

3. The air blower of claim 1, where the rotation housing is frictionally rotatable relative to the main housing.

4. The air blower of claim 1 where the rotation housing is rotated about a rotation axis that is the same as the rotation axis of the fan.

5. The air blower of claim 1, where the rotation housing is mounted to a rotation mount and the motor is mounted to a motor mount, where the rotation mount frictionally rotates relative to the motor mount.

6. The air blower of claim 5, where a rubberized o-ring is positioned between the rotation mount and motor mount for creating rotational friction force.

7. An air blower comprising:
a main housing having a head portion and a handle having a longitudinal axis;
an arm having a distal end and proximal end, where the proximal end of the arm is rotatably attached to the head portion;
a fan positioned within the head portion; and
a motor driving the fan, where the motor is positioned within the head portion.

8. The air blower of claim 7 further comprising a vortex lid positioned over the fan, where the vortex lid is configured to swirl air created by the fan.

9. The air blower of claim 8, where the vortex lid includes a channel for allowing air flow created by the fan to enter into the arm.

10. The air blower of claim 7, where the arm is rotatable between at least 0 and 180 degrees relative to the longitudinal axis of the handle.

11. The air blower of claim 10, where a controller is positioned on the handle and where the arm, when positioned at 0 degrees relative to the longitudinal axis of the handle, covers at least a portion of the controller.

12. The air blower of claim 7, where the handle includes a visual indicator for indicating operational states of the air blower.

13. The air blower of claim 7, where the visual indicator includes at least one light source.

14. The air blower of claim 7 where the handle includes a plug receptacle for charging a power source positioned with the handle.

15. An air blower comprising:
a main housing including a handle having a longitudinal axis;
an arm having a distal end and proximal end, where the proximal end of the arm is rotatably attached to the main housing, and where the distal end of the arm includes an air outlet;
a brush tip having brush bristles, where the brush tip is attached to the distal end of the arm;
a fan positioned within the main housing; and
a motor driving the fan.

16. The air blower of claim 15, where the brush tip can be moved along a longitudinal axis of the arm between a first position and second position.

17. The air blower of claim 15, where the brush tip includes circumferentially arranged brush bristles that create a central opening for air to pass through from the air outlet.

18. The air blower of claim 15, where the brush tip extends and retracts on the arm.

19. The air blower of claim 16, where the brush tip, when in its first position, extends from the air outlet, and where the brush tip, when in its second position, retracts towards the main housing.

20. The air blower of claim 19, where the air outlet extends through the brush bristles when the brush tip is in its second position.
